(19) United States
(12) Patent Application Publication
(10) Pub. No.: US 2019/0197555 A1
(43) Pub. Date: Jun. 27, 2019

(54) METHOD AND SYSTEM FOR FACILITATING PAYMENTS FOR ITEMS DELIVERED AT DELIVERY LOCATIONS

(71) Applicant: Mastercard International Incorporated, Purchase, NY (US)

(72) Inventors: Amit Gupta, Lucknow (IN); Ankur Arora, New Delhi (IN)

(73) Assignee: Mastercard International Incorporated, Purchase, NY (US)

(21) Appl. No.: 16/213,931

(22) Filed: Dec. 7, 2018

(30) Foreign Application Priority Data
Dec. 21, 2017 (SG) 10201710680U

(51) Int. Cl. G06Q 20/42; G06Q 20/40; G06Q 20/08; G06Q 30/06

(52) U.S. Cl. CPC G06Q 20/42; G06Q 20/4097; G06Q 30/0641; G06Q 20/085; G06Q 20/4018

(57) ABSTRACT

A method and system for facilitating payments for items delivered at delivery locations is provided. A server system associated with a payment network receives payment card information provided by a user in relation to an online purchase of an item. The online purchase of the item is associated with selection of a Payment on Delivery option. The server system determines if the online purchase of the item is authorized or not. If the online purchase is authorized, a transaction ID is generated by the online seller. The server system receives the transaction ID from item delivery personnel subsequent to the delivery of the item to the delivery location. In response to the receipt of the transaction ID, a notification is provided to the user. The payment to the online seller is processed subsequent to receiving confirmation of the receipt of the item at the delivery location from the user.

### CROSS REFERENCE TO RELATED APPLICATIONS

This application claims priority to Singaporean Application Serial No. 10201710680U, filed Dec. 21, 2017, which is incorporated herein by reference in its entirety

### TECHNICAL FIELD

The present disclosure relates to financial transactions, and more particularly, to a method and system for facilitating payments for items delivered at delivery locations.

### BACKGROUND

Online commerce, also known as electronic commerce (E-commerce), has seen an exponential rise in the recent years. Sellers of goods and services typically use digital platforms or Websites to showcase their offerings to existing and potential customers. A visitor to such a digital platform may choose to purchase an item on display and thereafter pay for the item using a banking card, such as a credit card, a debit card, a prepaid card, and the like. The purchased item may then be physically delivered to the online visitor as per the specified delivery schedule. For example, an online visitor may purchase a new phone model online and pay for the phone using a banking card. The purchased phone may then be delivered to a delivery location provided by the online visitor during the online purchase of the phone.

Nowadays, many online sellers provide an option to their customers to pay for a purchased item subsequent to delivery of the purchased item. For instance, in the above example, the online visitor may place an online order for the phone and then pay for the phone only when the phone is actually delivered to the online visitor. Such a mode of online payment is referred to as Cash on Delivery (COD) mode of payment and it is the most commonly used mode of online payment in many countries. The COD option in E-commerce is widely used, as customers are more comfortable paying after the product is physically delivered to them. However, many times, customers may not be present at their respective delivery locations to receive the items ordered online. In some scenarios, a neighbor or a security guard known to a customer may be willing to receive the item on behalf of the customer if the customer is not present at the delivery location to receive the item. However, payment in such a scenario may become a problem, as the recipient may be willing to receive the item on behalf of the customer but may be unwilling to pay on behalf of the customer. In such circumstances, the items are typically returned to the online sellers leading to a loss for the online sellers as well as frustration for the customers on account of delay in receipt of their respective purchased items.

### SUMMARY

Various embodiments of the present disclosure provide methods and system for facilitating payments of items delivered at delivery locations.

In one embodiment, a method for facilitating payments of items delivered at delivery locations is disclosed. The method includes receiving, by a server system associated with a payment network, payment card information provided by a user in relation to an online purchase of an item. The online purchase of the item is associated with selection of a Payment on Delivery (POD) option by the user. The selection of the POD option is configured to instruct the payment network to process payment to an online seller of the item subsequent to delivery of the item to a delivery location provided by the user. The method includes determining, by the server system, if the online purchase of the item is authorized based, at least in part, on verifying the payment card information. If the online purchase is authorized, the method includes receiving a transaction ID associated with the online purchase of the item by the server system. The online seller of the item generates the transaction ID. Subsequent to the delivery of the item to the delivery location, the method includes receiving the transaction ID, by the server system, from item delivery personnel. The method includes providing a notification, by the server system, to the user to request confirmation of receipt of the item at the delivery location. The notification is provided in response to the transaction ID received from the item delivery personnel. The method includes processing, by the server system, payment to the online seller subsequent to receiving confirmation of the receipt of the item at the delivery location from the user.

In one embodiment, a server system configured to facilitate payments of items delivered at delivery locations is disclosed. The server system is associated with a payment network and includes a processor and a communication interface in operative communication with the processor. The processor is configured to receive payment card information provided by a user in relation to an online purchase of an item. The online purchase of the item is associated with selection of a Payment on Delivery (POD) option by the user. The selection of the POD option is configured to instruct the payment network to process payment to an online seller of the item subsequent to delivery of the item to a delivery location provided by the user. The processor determines if the online purchase of the item is authorized based, at least in part, on verifying the payment card information. The communication interface is configured to receive a transaction ID associated with the online purchase of the item if the online purchase is authorized. The transaction ID is generated by the online seller of the item. Subsequent to the delivery of the item to the delivery location, the communication interface is configured to receive the transaction ID from item delivery personnel. The communication interface is further configured to provide a notification to the user to request confirmation of receipt of the item at the delivery location. The notification is provided in response to the transaction ID received from the item delivery personnel. The processor is configured to process payment to the online seller subsequent to receiving confirmation of the receipt of the item at the delivery location from the user.

In one embodiment, a method for facilitating payments of items delivered at delivery locations is disclosed. The method receives, by a processor, a transaction ID related to an online purchase of an item by a user. The transaction ID is received from item delivery personnel subsequent to delivery of the item to a recipient known to the user if the user is not present at a delivery location provided by the user. The method provides a notification, by the processor, to the user to request confirmation of receipt of the item at the delivery location. The notification provided to the user comprises at least one of: (1) an image configured to provide evidence of the delivery of the item to the recipient; and (2) a link capable of being selected by the user to provide confirmation of the receipt of the item at the delivery location. The method facilitates, by the processor, processing of payment to an online seller of the item subsequent to receiving confirmation of the receipt of the item at the delivery location from the user.

### BRIEF DESCRIPTION OF THE FIGURES

For a more complete understanding of example embodiments of the present technology, reference is now made to the following descriptions taken in connection with the accompanying drawings in which:

FIG. 1 is a schematic diagram illustrating an exemplary multi-party payment card system for enabling payment-by-card transactions in which merchants and card issuers do not necessarily have a one-to-one relationship;

FIG. 2 is a simplified block diagram illustrating communication between a server system of a payment network and a plurality of electronic devices, in accordance with one embodiment of the present invention;

FIG. 3 is a simplified block diagram of the server system of FIG. 2, in accordance with one embodiment of the present invention;

FIG. 4 illustrates an example configuration of an electronic device, in accordance with one embodiment of the present invention;

FIG. 5A shows a representation of a UI displaying a payment on delivery (POD) option to an online customer for facilitating an online purchase of an item, in accordance with one embodiment of the present invention;

FIG. 5B shows a representation of a UI associated with the Website of the online seller for facilitating provisioning of payment card information by an online customer, in accordance with one embodiment of the present invention;

FIG. 6A is a simplified representation of a UI configured to facilitate item delivery personnel to provision the transaction ID subsequent to the delivery of the item to a recipient at the delivery location provided by the online customer, in accordance with one embodiment of the present invention;

FIG. 6B shows a simplified representation of a UI corresponding to a notification provisioned to the online customer for confirming the receipt of the delivery at the delivery location, in accordance with one embodiment of the present invention;

FIG. 7 represents a sequence flow diagram for illustrating an example sequence of steps associated with facilitating payment for an item purchased online, in accordance with one embodiment of the present invention;

FIG. 8 is a flow diagram of an example method for facilitating payments for items delivered at delivery locations, in accordance with one embodiment of the present invention; and

FIG. 9 is a flow diagram of an example method for facilitating payments for items delivered at delivery locations, in accordance with another embodiment of the present invention.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Nowadays, many online sellers of products and services provide an option to their customers to pay for a purchased item subsequent to delivery of the purchased item. Such an option in E-commerce is widely used by the customers, as the customers are more comfortable paying after the product is physically delivered to them. However, many times, customers may not be present at their respective delivery locations to receive the items ordered online. In some scenarios, an individual known to the customer, such as a neighbor or security personnel, may be willing to receive the item on behalf of the customer if the customer is not present at the delivery location to receive the item. However, payment in such a scenario may become a problem, as the recipient may be willing to receive the item on behalf of the customer but may be unwilling to pay on behalf of the customer. In such circumstances, the items are typically returned to the online sellers leading to a loss for the online sellers as well as frustration for the customers on account of delay in receipt of their respective purchased items.

Various embodiments of the present invention provide methods and system for overcoming the above drawbacks and providing additional advantages. More specifically, various embodiments as disclosed herein facilitate payment for items delivered at delivery locations when the customers are not present at the respective delivery locations.

In an embodiment, a user (i.e. an online customer) may visit a Website of an online seller and engage in an online purchase of an item. The user may provide payment card information and a phone number in relation to the online purchase of the item. The user may further select a Payment on Delivery (POD) option for the online purchase of the item. The selection of the POD option is configured to instruct a payment network associated with the payment card information to process payment to an online seller of the item subsequent to delivery of the item to a delivery location provided by the user.

The payment card information provided by the user on the Web site of the online seller is sent to a server system associated with a payment network to determine if the online purchase of the item is authorized or not. To determine the authorization status, the server system may verify the payment card information. For example, the server system may verify the card number, expiry date, card verification value (CVV) and such other information from its stored records. The server system may also forward the payment card information to a bank associated with the issuance of the payment card. The bank is hereinafter referred to as the issuer bank. The issuer bank may check the available credit line and the balance in the customer's account to determine if the purchase is covered or not, and provision the status to the server system. The server system may determine if the online purchase of the item is authorized based on the information received from the issuer bank. If the online purchase of the item is deemed to be authorized, then this may be communicated to the online seller. The online seller may be configured to generate a transaction ID corresponding to the online purchase of the item. The online seller may further be configured to share the transaction ID with the server system as well as with the item delivery personnel assigned to deliver the purchased item to the user.

In one embodiment, the server system may be configured to receive money transfer for an amount equivalent to the billed amount for the online purchase of the item from the issuer bank. The server system may be configured to store the money along with the transaction ID and the phone number provided by the user.

The item delivery personnel may attempt to deliver the purchased item to the delivery location specified by the user. If the user is not present at the delivery location the item may be delivered to a recipient known to the user, such as for example a neighbor or a security guard at the delivery location. Subsequent to the delivery of the item to the delivery location, the item delivery personnel may use an application in an electronic device to send a transaction ID and an image configured to serve as evidence of the delivery of the item to the recipient. The transaction ID and the image may be forwarded to the server system. The server system may then be configured to provide a notification, such as for example a Short Message Service (SMS), to the user to request confirmation of receipt of the item at the delivery location. In some embodiments, the notification provided to the user includes an image configured to provide evidence of the delivery of the item to the recipient. The notification may also include a link capable of being selected by the user to provide confirmation of the receipt of the item at the delivery location. The user may select the link in the notification to provide the confirmation of the receipt of the item at the delivery location. The server system may then be configured to process payment to the online seller subsequent to receiving confirmation of the receipt of the item at the delivery location from the user. More specifically, the server system may transfer the money to a bank account associated with the online seller.

As explained above, payments for delivered items may be facilitated in spite of the customers (or the users) not being present at the delivery locations to receive their respective purchased items and pay for the purchased items. As a result, the purchased items may not be returned to the online seller thereby precluding a loss of time and money for the online seller. Moreover, the customer may receive the purchased item and pay for the purchased item in spite of not being present at the delivery location, thereby increasing a satisfaction level of the customer.

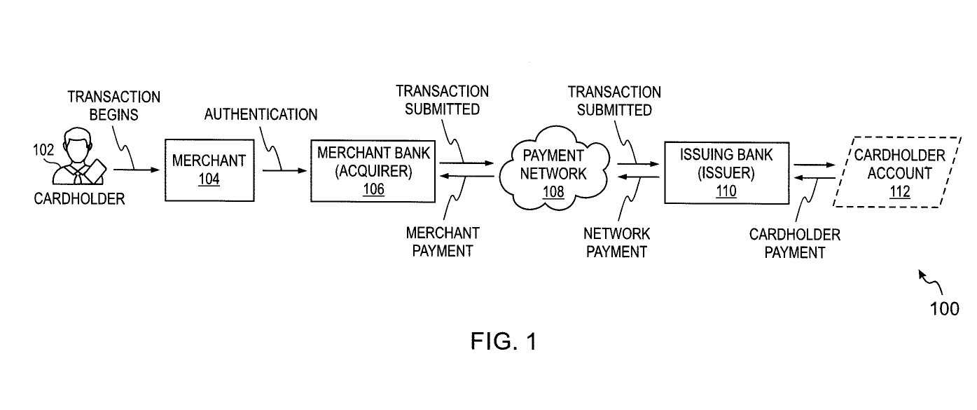

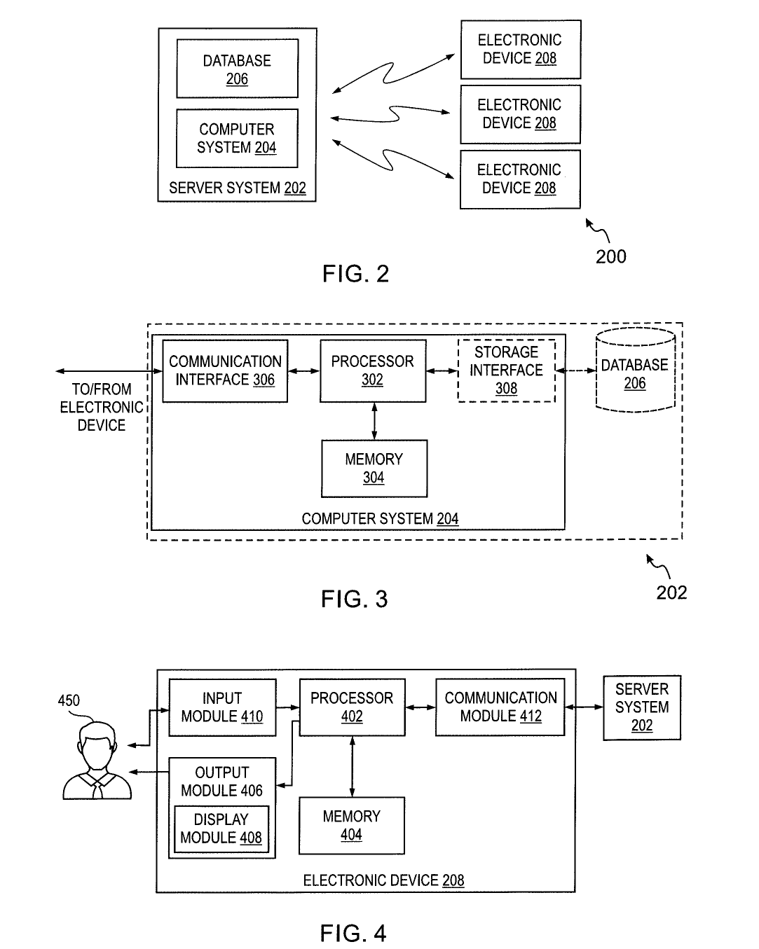

FIG. 1 shows a representation for illustrating a typical payment card based transaction. Various example embodiments of present invention are described with reference to FIGS. 2 to 9.

Referring now to FIG. 1, a schematic diagram illustrating an exemplary multi-party payment card system 100 for enabling payment-by-card transactions in which merchants and card issuers do not necessarily have a one-to-one relationship. The present invention relates to payment card system 100, such as a credit card payment system using a payment card system interchange network 108 such as the MasterCard® payment card system interchange network. MasterCard® payment card system interchange network is a proprietary communications standard promulgated by MasterCard International Incorporated for the exchange of financial transaction data between financial institutions that are members of MasterCard International Incorporated. (MasterCard is a registered trademark of MasterCard International Incorporated located in Purchase, N.Y.). The payment card system interchange network 108 is hereinafter referred to as payment network 108.

In payment card system 100, a financial institution such as an issuer 110 issues a payment account card, such as a credit card account or a debit card account, to a cardholder 102, who uses the payment account card to tender payment for a purchase from a merchant 104. In at least one embodiment, the merchant 104 is an online seller offering one or more products or services on a digital platform, such as an electronic commerce (E-commerce) platform. To accept payment with the payment account card, the merchant 104 must normally establish an account with a financial institution that is part of the financial payment system. This financial institution is usually called the “merchant bank” or the “acquiring bank” or “acquirer bank” or simply “acquirer”. When a cardholder 102 tenders payment for a purchase with a payment account card (also known as a financial transaction card), merchant 104 requests authorization from acquirer 106 for the amount of the purchase. The request may be performed over the telephone, or through the use of a point-of-sale (POS) terminal, which reads the cardholder's account information from the magnetic stripe on the payment account card and communicates electronically with the transaction processing computers of acquirer 106, or through payment gateways as in the case of online payment transactions. Alternatively, acquirer 106 may authorize a third party to perform transaction processing on its behalf. In this case, the point-of-sale terminal or the payment gateway will be configured to communicate with the third party. Such a third party is usually called a “merchant processor” or an “acquiring processor.”

Using payment network 108, the computers of acquirer 106 or the merchant processor will communicate with the computers of issuer 110 to determine whether the cardholder's account is in good standing and whether the purchase is covered by the cardholder's available credit line or account balance. Based on these determinations, the request for authorization will be declined or accepted. If the request is accepted, an authorization code is issued to merchant 104.

When a request for authorization is accepted, the available credit line or available balance of cardholder's account 112 is decreased. Normally, a charge is not posted immediately to a cardholder's account because bankcard associations, such as MasterCard International Incorporated, have promulgated rules that do not allow a merchant to charge, or “capture,” a transaction until goods are shipped or services are delivered. When a merchant ships or delivers the goods or services, merchant 104 captures the transaction by using, for example, appropriate data entry procedures. If a cardholder cancels a transaction before it is captured, a “void” is generated. If a cardholder returns goods after the transaction has been captured, a “credit” is generated.

For debit card transactions, when a request for a personal identification number (PIN) authorization is approved by the issuer 110, the cardholder's account 112 is decreased. Normally, a charge is posted immediately to cardholder's account 112. The bankcard association then transmits the approval to the acquiring processor for distribution of goods/services, or information or cash in the case of an ATM.

After a transaction is captured, the transaction is settled between merchant 104, acquirer 106, and issuer 110. Settlement refers to the transfer of financial data or funds between the merchant's account, acquirer 106, and issuer 110 related to the transaction. Usually, transactions are captured and accumulated into a “batch,” which is settled as a group.

Financial transaction cards or payment account cards refer to cards used as a method for payment for performing transactions. As described herein, the term “financial transaction card” or “payment account card” includes cards such as credit cards, debit cards, and prepaid cards, but also includes any other devices that may hold payment account information, such as mobile phones, personal digital assistants (PDAs), and key fobs. Financial transaction cards or payment account cards are hereinafter referred to as “payment cards”. The transactions performed using the payment cards are referred to as “payment card transactions” or “financial transactions”. An example of a financial transaction may include online payment for purchase of a product or a service.

FIG. 2 is a simplified block diagram 200 illustrating communication between a server system 202 of a payment network and a plurality of electronic devices, in accordance with one embodiment of the present invention. In one embodiment, the payment network may correspond to a payment card system interchange network such as the MasterCard® payment card system interchange network 108 explained with reference to FIG. 1. In one embodiment, the payment network may correspond to a transaction-processing network of an issuing bank (or the issuer 110 shown in FIG. 1). In one embodiment, the payment network may correspond to payment processing network of an online seller, such as an E-commerce company, for example. The server system 202 of the payment network is configured to facilitate payment card based financial transactions as explained with reference to FIG. 1.

The server system 202 of the payment network includes a computer system 204 and a database 206. As shown in FIG. 2, several electronic devices 208 are in operative communication with the server system 202. The electronic devices 208 may be interconnected to the Internet through many interfaces including a network, such as a local area network (LAN) or a wide area network (WAN), dial-in-connections, cable modems, and special high-speed ISDN lines.

In one embodiment, one of electronic devices 208 may correspond to a personal computing device of a user (also referred to herein as an online customer) associated with one or more payment cards. Some non-exhaustive examples of the personal computing device may include a smartphone, a laptop, a desktop, a workstation terminal, a wearable device, a tablet computer, a personal digital assistant (PDA), and the like.

In one embodiment, one of electronic devices 208 may be associated with an acquirer while another one of electronic devices 208 may be associated with an issuer.

In one embodiment, one of electronic devices 208 may be associated with an online seller while another one of electronic devices 208 may be associated with item delivery personnel responsible for delivery of items to delivery locations specified by the users.

The server system 202 is explained in further detail with reference to FIG. 3.

FIG. 3 is a simplified block diagram of the server system 202 of FIG. 2, in accordance with one embodiment of the present invention. As explained above, the server system 202 is a part of the payment network. The server system 202 includes the computer system 204 and the database 206.

The computer system 204 includes a processor 302 for executing instructions. Instructions may be stored in, for example, but not limited to, a memory 304. Processor 302 may include one or more processing units (e.g., in a multi-core configuration).

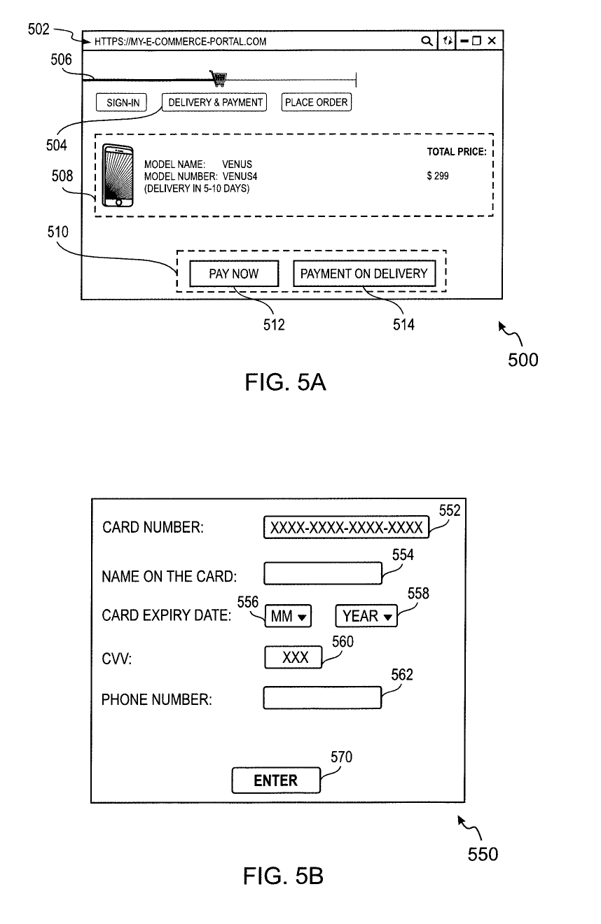

The processor 302 is operatively coupled to a communication interface 306 such that computer system 204 is capable of communicating with a remote device such as an electronic device 208 (shown in FIG. 2). For example, the communication interface 306 may receive requests from an electronic device 208 associated with an online customer, an online seller, an item delivery personnel and the like, via the Internet, for facilitating payments for items delivered at delivery locations, as will be explained later with reference to FIGS. 5A to 7.

The processor 302 may also be operatively coupled to the database 206. The database 206 is any computer-operated hardware suitable for storing and/or retrieving data, such as, but not limited to, transaction data generated as part of sales activities conducted over the bankcard network including data relating to merchants, account holders or customers, and purchases. The database 206 may also store information related to a plurality of user accounts. Each user account data includes at least one of a cardholder name, a cardholder address, an account number, and other account identifiers. Further, information related to one or more payment cards associated with respective user may also be stored in the database 206. It is noted that each payment card from among the one or more payment cards is capable of facilitating at least one financial transaction. The database 206 may also store merchant data including a merchant identifier that identifies each merchant registered to use the payment network 200, and instructions for settling transactions including merchant bank account information. The database 206 may include multiple storage units such as hard disks and/or solid-state disks in a redundant array of inexpensive disks (RAID) configuration. The database 206 may include a storage area network (SAN) and/or a network attached storage (NAS) system.

In some embodiments, the database 206 is integrated within computer system 204. For example, computer system 204 may include one or more hard disk drives as database 206. In other embodiments, database 206 is external to computer system 204 and may be accessed by the computer system 204 using a storage interface 308. The storage interface 308 is any component capable of providing processor 302 with access to the database 206. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 302 with access to the database 206.

FIG. 4 illustrates an exemplary configuration of an electronic device 208, in accordance with one embodiment of the invention. The electronic device 208 may correspond to a personal computing device of a consumer, a computing device associated with an acquirer or an issuer, a computing device associated with an online seller or an electronic device associated with an item delivery personnel, and the like.

The electronic device 208 includes a processor 402 for executing instructions. In some embodiments, executable instructions are stored in a memory 404. The processor 402 may include one or more processing units (e.g., in a multi-core configuration). The memory 404 is any device allowing information such as executable instructions and/or transaction data to be stored and retrieved. The memory 404 may include one or more computer readable media.

The electronic device 208 also includes an output module 406 for presenting information to a user 450 (such as an online customer, item delivery personnel and the like). The output module 406 is any component capable of conveying information to the user 450. In some embodiments, output module 406 includes an output adapter (not shown) such as a video adapter and/or an audio adapter. An output adapter is operatively coupled with the processor 402 and with an output device such as a display module 408 (e.g., a cathode ray tube (CRT), liquid crystal display (LCD), light emitting diode (LED) display, or “electronic ink” display) or an audio output device (e.g., a speaker or headphones). In some embodiments, display module 408 is configured to present a graphical user interface (e.g., a web browser and/or a client application) to the user 450. A graphical user interface may correspond to, for example, an online store interface for viewing and/or purchasing items, a wallet application for managing payment information, and/or item delivery application for providing confirmation of the delivery of the item purchased online to a delivery location specified by the user.

In some embodiments, electronic device 208 includes an input module 410 for receiving input from the user 450. The user 450 may use input module 410 to select one or more items to purchase, to enter credential and/or payment information, to confirm delivery of the item, and the like. In some embodiments, the user 450 may use the input module 410 to enter a transaction ID, to upload a captured image, and the like. The input module 410 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both the display module 408 of the output module 406 and the input module 410.

The electronic device 208 also includes a communication module 412, which is configured to communicate with a remote device such as the server system 202 (explained with reference to FIG. 3). The electronic device 208, using the communication module 412, may be interconnected to the Internet through many interfaces including a network, such as a local area network (LAN) or a wide area network (WAN), dial-in-connections, cable modems, and special high-speed ISDN lines. The communication module 412 may include, for example, a wired or wireless network adapter and/or a wireless data transceiver for use with a mobile telecommunications network.

Stored in memory 404 are, for example, computer readable instructions for providing a user interface (UI) to the user 450 via the display module 408 and, optionally, receiving and processing input from the input module 410. A UI may include, among other possibilities, a Web browser and/or a client application. Web browsers enable users, such as the user 450, to display and interact with media and other information typically embedded on a Web page or a Website from the server system 202. A client application allows the user 450 to interact with a server application of a merchant computer system, and/or the server system 202.

In at least some embodiments, the user 450 may use an electronic device 208 embodied as a personal computing device to create a user account with the payment network. More specifically, the user 450 may access the computer system 204 associated with the payment network to create a user account. As explained above, the electronic device 208 includes a communication module 412 capable of interconnecting the electronic device 208 to the Internet. The user 450 may use the electronic device 208 to connect to the Internet and access a Web-based UI associated with the computer system 204. The computer system 204 of the server system 202 is also interconnected to the Internet using the communication interface 306 (depicted in FIG. 3). In one embodiment, the Web-based UI may correspond to a Website associated with the payment network. The user 450 may provide personal information, such as name, address, email ID, phone number and such other details for creation of the user account. In one embodiment, the user 450 may also provide a number, such as social security number or a personal account number (PAN) assigned to the user by a governmental agency to uniquely identify the user. Such a number may be stored as a unique identification number in the database 206 as part of the user account information.

As explained above, in some embodiments, the user 450 may correspond to an online customer and the electronic device 208 may correspond to a personal computing device of the online customer. The online customer may use the electronic device 208 to access a Website or a digital platform of an online seller offering products or services for sale. The various products and/or services offered for sale on a Website of an online seller are collectively referred to hereinafter as ‘items’ and individually referred to hereinafter as an ‘item’. The online customer may view several items of interest displayed on the Web pages associated with the Website and choose an item for purchase. The online customer may thereafter provide payment card information to initiate online purchase of the item. In an illustrative example, the online seller may correspond to an electronic commerce (E-commerce) entity and the Website may correspond to an E-commerce portal offering a variety of products such as electronic goods, kitchen appliances, sporting equipment, and the like, for customer consumption. In an example scenario, an online customer may be interested in purchasing a Smartphone and accordingly, may view several phone models of interest displayed on the Web pages associated with the Website and choose a phone model for purchase. An example Web page UI displayed to a customer on the E-commerce portal for facilitating online purchase of an item, i.e. a phone model, is shown in FIG. 5A.

FIG. 5A shows a representation of a UI 500 displaying a payment on delivery (POD) option to an online customer for facilitating an online purchase of an item, in accordance with one embodiment of the present invention. In one embodiment, the UI 500 corresponds to a Web page associated with a Website of an online seller. It is understood that the Website of the online seller may include several Web pages displaying a plurality of items on sale. Further, it is understood that several online customers may visit the Website of the online seller for viewing items offered for sale and at least some online customers may purchase one or more items of interest. Each online customer may access the Website of the online seller by entering a uniform resource locator (URL) in a Web browser application installed in his or her respective electronic device. An example URL used for accessing a Website of the online seller is shown as URL 502 in FIG. 5A. It is noted that the URL 502 is depicted as ‘https://my-e-commerce-portal.com’ for illustration purposes.

The UI 500 shows a representation of an example scenario, where an online customer has selected a phone model for purchase. The UI 500 may be presented to the online customer subsequent to receiving indication from the online customer for initiating a purchase transaction corresponding to the selected phone model. In an example scenario, the online customer may select a tab ‘Delivery and Payment’ 504 shown on a Web session timeline 506 to provide the indication to the Website to initiate the purchase transaction corresponding to the selected phone model.

The UI 500 is depicted to include an information section 508 and a payment option selection section 510. The information section 508 is depicted to display details related to the phone model selected for purchase by the online customer. Accordingly, the information section 508 depicts a phone model name (exemplarily depicted as ‘Venus’), a phone model number (exemplarily depicted as ‘Venus 4’), cost of the phone (exemplarily depicted as $299) and an estimated delivery time (exemplarily depicted as 5-10 days). The payment option selection section 510 is depicted to display two buttons 512 and 514 displaying text ‘PAY NOW’ and ‘PAYMENT ON DELIVERY’, respectively. The selection of the button 512 may cause the payment network associated with the payment card of the online customer to initiate processing of payment to the online seller from a banking account associated with the online customer. The selection of the button 514 may instruct the payment network to process payment to an online seller of the item subsequent to delivery of the item to a delivery location specified by the user. More specifically, the selection of the PAY NOW′ option may cause initiation of the process of payment to the online seller without waiting for the item to be delivered to the user, whereas the selection of the ‘PAYMENT ON DELIVERY’ option (hereinafter referred to as the ‘POD’ option) may cause the payment network to withhold the payment to the online seller till the item is delivered to the delivery location specified by the online customer. It is noted that some customers may be more comfortable in paying for an item only upon receiving the item and ensuring that the item is delivered as per their satisfaction. Such customers may choose the POD option for paying for online purchases of items. However, it is noted, that many customers may choose the PAY NOW′ option for completing the online purchase transaction. The selection of either of the buttons 512 or 514 may cause display of another UI providing a plurality of payment methods, such as for example, payment by a payment card such as a credit card, a debit card or a prepaid card, payment using net banking or payment using a Cash on Delivery (COD) option, and the like. In one embodiment, the online customer may select a payment card based payment method for the POD option. Subsequent to selection of such a payment method, the online customer may be directed to a UI for entering the payment card information for purchasing the smartphone, online. An example UI configured to enable the online customer to enter payment card information is shown in FIG. 5B.

FIG. 5B shows a representation of a UI 550 associated with the Web site of the online seller for facilitating provisioning of payment card information by an online customer, in accordance with one embodiment of the present invention. As explained with reference to FIG. 5A, an online customer may choose an item of interest, such as for example a phone model, and subsequently initiate an online purchase transaction by selecting a tab, such as the tab 504 (shown in FIG. 5A) and thereafter selecting a payment option and a payment method, such as for example the POD option and a payment card based payment method. Upon receiving such selections from the online customer, the Website of the online seller may be configured to provision a UI, such as the UI 550, for facilitating provisioning of the payment card information by the online customer.

In one embodiment, the UI 550 is depicted to display a plurality of form fields, such as form fields 552, 554, 556, 558, 560 and 562 for facilitating provisioning of the payment card information by the online customer. Each form field from among the form fields 552-562 is capable of receiving a user input, such as a text input or a selection input. For example, the form field 552 is depicted to be associated with text ‘Card Number’. The online customer may provide a 16-digit numerical input corresponding to the number of the payment card in the form field 552. In one embodiment, the form field 552 may be capable of receiving input in form of ‘XXXX-XXXX-XXXX-XXXX’, where ‘X’ corresponds to a positive integer. In one embodiment, the online customer may sequentially input the digits of the payment card number and the form field 552 may be configured to align the numbers in the form, depicted above. In some embodiments, the UI 550 may also include another form field, such as the form field 552, requesting the user to reconfirm the payment card number and the Website may be configured to display an error flag if the payment card number entered in the two form fields do not match.

The form field 554 is depicted to be associated with text ‘Name on the Card’ and the online customer may provide a string of alphabets corresponding to the name of the individual displayed on the payment card in the form field 554. The form fields 556 and 558 are depicted to be associated with text ‘Card Expiry Date’, and the online customer may provide a selection input corresponding to the month and year of the expiry of the payment card displayed on the payment card in the form fields 556 and 558, respectively.

The form fields 560 and 562 are depicted to be associated with text ‘CVV’ and ‘Phone Number’, respectively. Accordingly, the online customer may provide corresponding information in the respective form fields. For example, the form field 560 may be configured to receive a 3-digit numerical input corresponding to the Card Verification Value (CVV) of the payment card. In one embodiment, the form field 560 may be capable of receiving customer input in form of ‘XXX’, where ‘X’ corresponds to a positive integer.

It is noted that the information provided in the form fields 552-560 by the online customer configures the ‘payment card information’ for the purposes of the description. More specifically, the customer input in the form fields for payment card number, name on the card, payment card expiry details and CVV configure the payment card information.

The online customer may select the button 570 exemplarily depicted to display text ‘Enter’ to provide confirmation of the information included in the form fields 552-562. Upon customer selection of the button 570, the Website of the online seller may be configured to provision the payment card information along with indication that the payment card information is associated with the customer selection of the POD option to the server system 202. In at least one example embodiment, the Website of the online seller may also provision the phone number along with payment card information to the server system 202. The provisioning of such information may be performed over a communication network as explained with reference to FIGS. 2 and 3. In one embodiment, the payment card information may be provisioned to the server system 202 to determine if the online customer is authorized to perform the online purchase of the item (i.e. the phone model) or not. Further, the phone number may be provided to the server system 202 to facilitate confirmation of the delivery of the item to a delivery location specified by the online customer, as will be explained in further detail later.

In at least one example embodiment, the server system 202 associated with the payment network is configured to facilitate determination of whether the online customer is authorized to perform the online purchase of the item or not. As explained with reference to FIG. 3, the server system 202 associated with the payment network is configured to store (for example, in the database 206) information related to payment cards associated with various users.

The communication interface 306 associated with the server system 202 may be configured to receive the payment card information provisioned by the Website of the online seller. The payment card information may be forwarded to the processor 302 by the communication interface 306. As explained with reference to FIG. 1, using payment network (i.e., using the server system 202 associated with the payment network), the computers of acquirer 106 or the merchant processor may communicate with the computers of issuer 110 to determine whether the cardholder's account is in good standing and whether the purchase is covered by the cardholder's available credit line or account balance. Based on these determinations, the authorization for online purchase is declined or accepted. If the payment card information is verified, the online purchase is authorized.

If the online customer is determined to be authorized to perform the online purchase of the item, the processor 302 through the communication interface 306, may be configured to convey such confirmation to the Web site of the online seller. The Web site of the online seller, subsequent to receiving such communication from the online customer, may request the online customer, for example by using another UI, to specify a delivery location to facilitate completion of the online purchase transaction. The online customer may provide a textual input corresponding to the address of the delivery address to complete the online purchase of the item. The online seller, or more specifically, the Website of the online seller may be configured to generate a transaction ID, i.e. a code of predefined length including alphabets, numerical digits and the like, to uniquely identify the purchase transaction. In at least one example embodiment, the Website of the online seller may be configured to provision the transaction ID to the server system 202.

As explained with reference to FIG. 3, a plurality of user accounts may be stored in the database 206. The database 206 may include payment card information corresponding to various payment cards associated with each user. In some embodiments, individual users may create respective user accounts by accessing the digital platform associated with the server system 202. In some embodiments, the user accounts may be created by the server system 202 without any user intervention. It is noted that a user account may be created for each unique user and the user account may include information related to one or more payments associated with the respective user. In at least one example embodiment, the communication interface 306 of the server system 202 may be configured to receive the transaction ID and link the transaction ID and the phone number associated with the online purchase of the item to a user account including the payment card information associated with the online purchase of the item.

In at least one example embodiment, the server system 202 is configured to initiate a transfer of money equivalent to a billed amount corresponding to the online purchase of the item from a banking account linked with the payment card information to the user account in the payment network. More specifically, subsequent to the successful authorization of the online customer for performing the online purchase of the item, the billed amount of money may be transferred from the customer's banking account to a user account (associated with the customer's payment card) in the database 206. Accordingly, the available credit line or available balance of cardholder's account is decreased. Further, the server system 202 is configured to store the money (for example, the funds may be reflected) in the corresponding user account that is linked to the transaction ID and the phone number associated with the user. As explained with reference to FIG. 5A, since the online purchase of the item is associated with selection of the POD option, the money corresponding to the online purchase is withheld in the user account and not transferred to the account of the online seller until the item is delivered to the delivery location specified by the online customer.

In at least one example embodiment, the online seller, through the Website or through any other application, is configured to share the transaction ID with an item delivery personnel assigned with delivering the item to the delivery location. The item delivery personnel may then attempt to deliver the item to the delivery location specified by the online customer during the online purchase of the item.

In some scenarios, the online customer may not be present at the delivery location for receiving the item from the item delivery personnel. In such a scenario, the item delivery personnel may deliver the item to a recipient known to the user, such as for example a neighbor, a security guard, a friend or a relative of the online customer, and the like, present at the delivery location. In some example scenarios, the online customer may have intended the item to be delivered to a known recipient, such as for example a friend or a relative. In such scenarios, the item delivery personnel may deliver the item to the intended recipient.

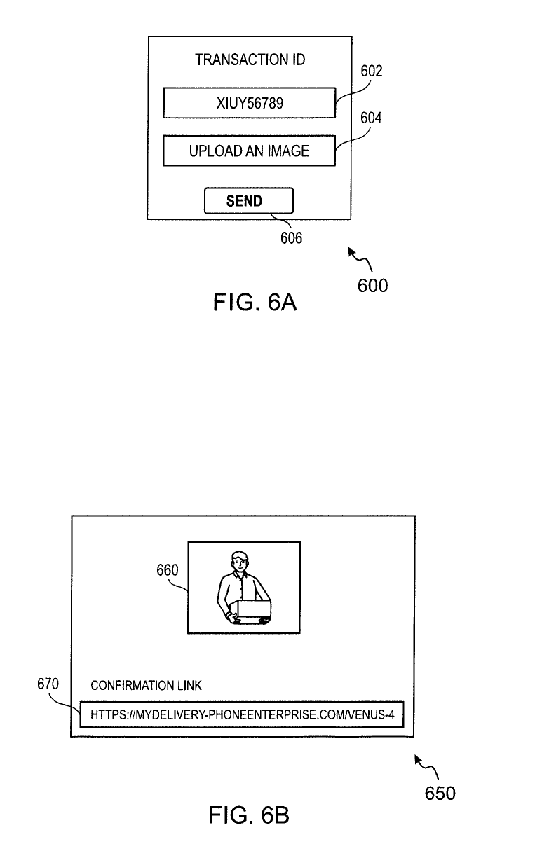

In at least one example embodiment, the item delivery personnel may be associated with an electronic device including an application configured to receive input related to the transaction ID from the item delivery personnel. The item delivery personnel may access the application on the electronic device and input the transaction ID in the application to confirm the safe delivery of the item to the delivery location. In at least one example embodiment, the item delivery personnel may also be configured to capture an image of the recipient with the item and upload the image with the transaction ID to provide evidence of the delivery of the item to the delivery location. In at least one example embodiment, the application on the electronic device may be configured to provision the transaction ID and the image to at least one of the online seller of the item and the server system 202 associated with the payment network. The provisioning of the transaction ID and the image by the item delivery personnel is further explained with reference to FIG. 6A.

FIG. 6A is a simplified representation of a UI 600 configured to facilitate item delivery personnel to provision the transaction ID subsequent to the delivery of the item to a recipient at the delivery location specified by the online customer, in accordance with one embodiment of the present invention. As explained with reference to FIG. 5B, the transaction ID may be generated by the Website of the online seller subsequent to completion of the online purchase of the item. The transaction ID may thereafter be shared with the item delivery personnel assigned with delivering the item to the delivery location specified by the customer. Further, as explained with reference to FIG. 5B, an electronic device associated with item delivery personnel may include an application configured to facilitate provisioning of a transaction ID to at least one of the online seller and the server system 202 subsequent to the delivery of the item at the delivery location specified by the online customer. The application upon being accessed by the item delivery personnel may display a UI, such as the UI 600, configured to enable the item delivery personnel to provide an input corresponding to the transaction ID.

The UI 600 is depicted to include a form field 602 configured to receive a textual input corresponding to the transaction ID. The transaction ID entered by the online customer is exemplarily depicted as ‘XIUY56789’ for illustration purposes. As explained with reference to FIG. 5B, the transaction ID is a code of predefined length and configured to uniquely identify the online transaction corresponding to the online purchase of the item (i.e., mobile phone). The UI 600 further depicts a selectable option 604 displaying text ‘Upload an image’ and configured to enable the item delivery personnel to upload an image. In some example scenarios, the online customer may not be present at the delivery location to receive the item from the item delivery personnel. In such scenarios, the item delivery personnel may deliver the item to a recipient known to the user if the user is not present at the delivery location. Further, the item delivery personnel may capture an image of the recipient with the item and upload the image to serve as evidence of the delivery of the item at the delivery location. To that effect, the electronic device of the item delivery personnel may be configured to include an image-capturing element such as an image sensor (or a camera) configured to facilitate capturing of an image of the recipient with the delivered item.

The UI 600 further depicts a button 606 displaying text ‘Send’. The item delivery personnel may select the button 606 to provision the transaction ID and the captured image to at least one of the online seller and the server system 202. It is noted that if the online customer is present at the delivery location to receive the item then is some embodiments, the item delivery personnel may preclude the capturing of the image and may select the button 606 to provision the transaction ID to confirm the delivery of the item at the delivery location to at least one of the online seller and the server system 202.

In a scenario where the transaction ID is sent from the application to only the online seller, the online seller may forward the transaction ID to the server system 202. The communication interface 306 of the server system 202 may be configured to receive the transaction ID and forward the transaction ID and/or the captured image to the processor 302 of the server system 202.

The processor 302, subsequent to receiving the transaction ID from the item delivery personnel compares it with the transaction ID as shared by the online seller and stored in the database 206. Upon a successful match of both the transaction IDs, the server system 202 is configured to provide a notification to the online customer to request confirmation of receipt of the item at the delivery location. The provisioning of the notification is explained with reference to a UI in FIG. 6B.

Referring now to FIG. 6B, a simplified representation of a UI 650 corresponding to a notification provisioned to the online customer for confirming the receipt of the delivery at the delivery location is shown, in accordance with one embodiment of the present invention. The server system 202, or more specifically the processor 302 of the server system 202, is configured to provision a notification to the online customer in response to receiving the transaction ID from the item delivery personnel. The notification may be sent to confirm the delivery of the item at the delivery location specified by the online customer. In one embodiment, the notification is embodied as a Short Message Service (SMS) and sent to the phone number provided by the online customer during the online purchase of the item. Alternatively, the notification may be provided by the server system 202, to the online customer in form of an email or an instant chat messenger notification.

The UI 650 as displayed in FIG. 6B corresponds to an SMS notification provisioned to the online customer on the phone number provided by the online customer during the online purchase of the item. As such the UI 650 may be displayed on the electronic device of the online customer. The UI 650 is depicted to display an image 660 showing an individual holding a package corresponding to the item ordered by the online customer. The individual may correspond to the recipient of the item delivered by the item delivery personnel. The UI 650 further depicts a hyperlink 670 capable of being selected by the online customer to confirm the receipt of the item at the delivery location. The image 660 may provide visual assurance to the online customer of the delivery of the item at the delivery location and the online customer may select the hyperlink 670 to provide confirmation of the receipt of the item at the delivery location.

In at least one embodiment, the server system 202 is configured to process payment to the online seller subsequent to receiving confirmation of the receipt of the item at the delivery location from the online customer. More specifically, subsequent to receiving confirmation of the receipt of the item from the user, the server system 202 is configured to transfer the money from the user account to an online seller account (e.g., acquirer 106 of FIG. 1) associated with the online seller. This may be enabled by the server system 202 by retrieving the stored money from the corresponding user account that is linked to the transaction ID, and facilitating the transfer of the money from the user account to an online seller account associated with the online seller for processing payment to the online seller. Thus, the payment for an item purchased online may be executed subsequent to the delivery of the item at the delivery location.

Accordingly, the online customers may choose the POD option during the online purchase of their respective items and may still be able to receive and pay for items in spite of not being present at the delivery locations specified by them during their respective online purchase of the items. The items may be delivered as per the delivery schedule even if the intended recipients of the items are not available at the respective delivery locations to receive the items, thereby saving on sizable cost for the online sellers. Moreover, the customer satisfaction quotient may improve as the items are delivered as per the delivery schedule and they do not have to endure their items being sent back and redelivered at a later point in time.

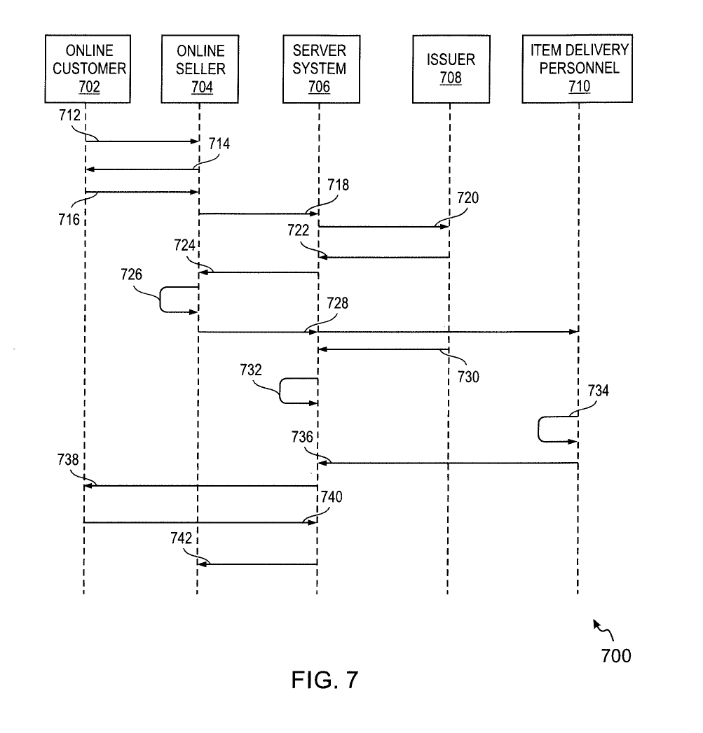

FIG. 7 represents a sequence flow diagram 700 for illustrating an example sequence of steps associated with facilitating payment for an item purchased online, in accordance with one embodiment of the present invention. The sequence flow diagram 700 depicts a plurality of blocks, such as blocks 702, 704, 706, 708 and 710. The blocks 702, 704, 706, 708 and 710 represent an online customer, an online seller, a server system associated with a payment network, an issuer and item delivery personnel, respectively. The server system 706 may be similar to the server system 202 explained with reference to FIGS. 2 to 6B.

The sequence flow diagram 700 starts at 712. At 712, the online customer 702 accesses a Website associated with the online seller 704 using an electronic device (such as the electronic device 208 explained with reference to FIG. 4) and selects a payment on delivery (POD) option for an item selected to be purchased on the Website.

At 714, subsequent to receiving customer selection of the POD option, the Website of the online seller 704 is configured to provision a UI, such as the UI 500 explained with reference to FIG. 5A, for enabling the online customer 702 to provision payment card information and phone number for facilitating online purchase of the item.

At 716, the online customer 702 provides input corresponding to the payment card information along with a phone number on the UI using an input interface of the electronic device. The payment card information generally includes information such as payment card number, cardholder name, payment card expiry date, payment card verification value (CVV), and the like. The online customer 702 may also provide a phone number for receiving notifications for confirming the receipt of the delivery of the items at the delivery location.

At 718, the Website of the online seller 704 is configured to send the payment card information to the server system 706 for determining if the online purchase of the item is authorized or not. The online seller 704 may also send the phone number provided by the online customer 702 to the server system 706.

At 720, the server system 706 is configured to communicate with the issuer 708 (i.e. the payment card issuing bank) to determine if the cardholder account has sufficient funds to purchase the item and if the cardholder account is in good standing or not.

At 722, the issuer provides the requested information to the server system 706, which determines whether the online purchase of the item is authorized or not. If the online purchase of the item is determined to be authorized, then at 724, the server system 706 conveys the authorization to the online seller 706 (or more specifically to the Website of the online seller 706).

At 726, the online seller 706 generates a transaction ID corresponding to the online purchase transaction. The transaction ID is configured to uniquely identify the purchase transaction.

At 728, the online seller 706 is configured to share the transaction ID with server system 706 and the item delivery personnel 710.

At 730, the server system 706 is configured to receive a transfer of money corresponding to the billed amount for the online purchase of the item from the online customer's banking account (i.e. from the issuer 708) to a user account at the server system 706.

At 732, the server system 706 is configured to store the money along with transaction ID and the phone number associated with the online purchase of the item.

At 734, the item delivery personnel 710 delivers the item to the delivery location specified by the online customer 702 during the online purchase of the item. If the online customer 702 is not present at the delivery location to receive the item from the item delivery personnel 710, then the item delivery personnel 710 may deliver the item to a recipient known to the online customer 702, such as for example a neighbor, a family member, or a security guard, present at the delivery location.

At 736, the item delivery personnel 710 sends the transaction ID to the server system 706. In some embodiments, the transaction ID may be sent to the online seller 704 and the online seller 704 may then forward the transaction ID to the server system 706. Moreover, in some embodiments, the item delivery personnel 710 may also send an image of the recipient of the item if the online customer 702 was not present at the delivery location and the item was delivered to a recipient known to the online customer 702.

At 738, the server system 706 may send a notification to the online customer 702 at the phone number provided by the online customer 702 during the online purchase of the item to confirm the receipt of the delivery of the item at the delivery location. The notification may be embodied as a SMS, an email message, and the like. The notification may include a link capable of being selected by the online customer 702 to confirm receipt of the delivery of the item at the delivery location. In some embodiments, the notification may also include the image showing the recipient holding the delivered item.

At 740, the online customer 702 may select the link in the notification to provide confirmation of the receipt of the delivery item to the server system 706.

At 742, the server system 706, subsequent to receiving the confirmation, may facilitate transfer of the money to the online seller at 704, thereby facilitating payment to the online seller subsequent to the delivery of the item at the delivery location.

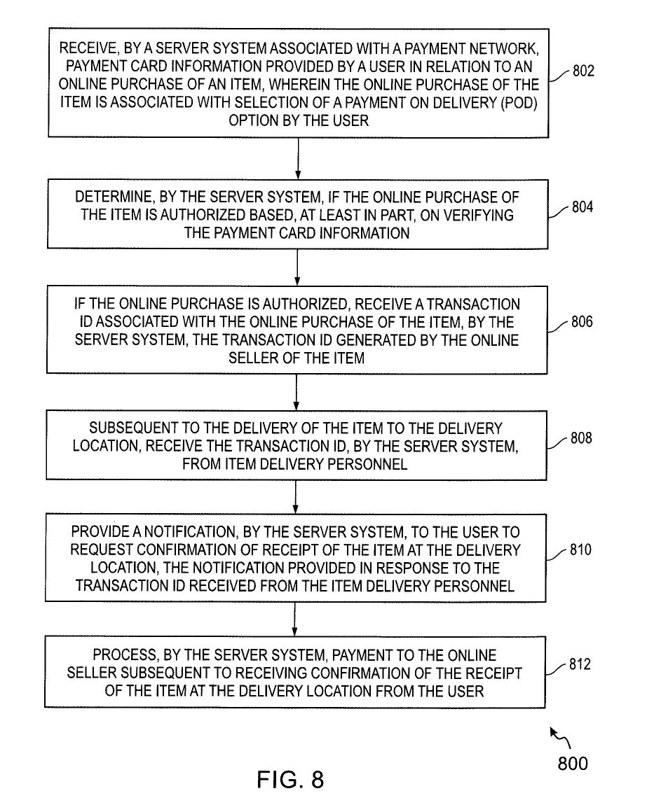

FIG. 8 is a flow diagram of an example method 800 for facilitating payments for items delivered at delivery locations, in accordance with one embodiment of the present invention. The method 800 depicted in the flow diagram may be executed by, for example, the server system 202 explained with reference to FIGS. 2 to 6B. Operations of the flowchart, and combinations of operation in the flowchart, may be implemented by, for example, hardware, firmware, a processor, circuitry and/or a different device associated with the execution of software that includes one or more computer program instructions. The operations of the method 800 are described herein with help of the server system 202. It is noted that the operations of the method 800 can be described and/or practiced by using a system other than the server system 202. The method 800 starts at operation 802.

At operation 802, payment card information provided by a user (hereinafter referred to as ‘online customer’) in relation to an online purchase of an item is received by a server system associated with a payment network, such as the server system 202 explained with reference to FIGS. 2 to 6B. As explained with reference to FIG. 4, several online customers may visit a Website of the online seller for viewing items offered for sale and at least some online customers may purchase one or more items of interest. In an example scenario, an online customer may select an item for purchase and a UI, such as the UI 500 shown in FIG. 5A, may be presented to the online customer subsequent to receiving indication from the online customer for initiating a purchase transaction corresponding to the selected item. The UI may display the details of the item being purchased and a payment on delivery (POD) payment option. The selection of the POD option is configured to instruct the payment network to process payment to an online seller of the item subsequent to delivery of the item to a delivery location provided by the online customer. The online customer may then be presented a UI, such as the UI 550 shown in FIG. 5B, requesting the online customer to provide payment card related information, such as the payment card number, the name on the payment card, the payment card expiry date and the card verification value (CVV) towards the online purchase of the item. Such information provided by the online customer on the Website may be sent to the server system. The server system may receive payment card information provided by the online customer during the online purchase of the item. In an embodiment, the online customer may also provide a phone number along with the payment card information, which may be sent to the server system.

At operation 804, it is determined by the server system whether the online purchase of the item is authorized based, at least in part, on verifying the payment card information. To that effect, the server system may send the payment card information to the issuer (i.e. computers of issuer 110 shown in FIG. 1) to determine whether the cardholder's account is in good standing and whether the purchase is covered by the cardholder's available credit line or account balance. Based on these determinations, the authorization for online purchase is declined or accepted. If the payment card information is verified, the online purchase is authorized.

If the online purchase is authorized, the online seller of the item generates a transaction ID corresponding to the online purchase of the item. The online seller sends the transaction ID to the server system and shares the transaction ID with the item delivery personnel assigned with delivering the item to the delivery location. At operation 806, a transaction ID is received by the server system.

In an embodiment, subsequent to the successful authorization of the online customer for performing the online purchase of the item, the billed amount of money is transferred from the customer's banking account to a customer account (associated with the online customer's payment card) in the database. Accordingly, the available credit line or available balance of cardholder's account is decreased. Further, the server system is configured to store the received the money in the corresponding user account that is linked to the transaction ID.

In an embodiment, the item delivery personnel may then attempt to deliver the item to the delivery location specified by the online customer during the online purchase of the item. In some scenarios, the online customer may not be present at the delivery location for receiving the item from the item delivery personnel. In such a scenario, the item delivery personnel may deliver the item to a recipient known to the user, such as for example a neighbor, a security guard, a friend or a relative of the online customer, and the like, present at the delivery location.

In at least one example embodiment, the item delivery personnel may be associated with an electronic device including an application configured to receive input related to the transaction ID from the item delivery personnel. The item delivery personnel may access the application on the electronic device and input the transaction ID in the application to confirm the safe delivery of the item to the delivery location. In at least one example embodiment, the item delivery personnel may also be configured to capture an image of the recipient with the item and upload the image with the transaction ID to provide evidence of the delivery of the item to the delivery location. In at least one example embodiment, the application on the electronic device may be configured to provision the transaction ID and the image to at least one of the online seller of the item and the server system. At operation 808, transaction ID is received by the server system from item delivery personnel.

At operation 810, a notification is provided by the server system to the user to request confirmation of receipt of the item at the delivery location. The notification is provided in response to the transaction ID received from the item delivery personnel. The notification may be sent to confirm the delivery of the item at the delivery location specified by the online customer. In one embodiment, the notification is embodied as a Short Message Service (SMS) and sent to the phone number provided by the online customer during the online purchase of the item. Alternatively, the notification may be provided by the server system, to the online customer in form of an email or an instant chat messenger notification. The notification may include a hyperlink capable of being selected by the online customer to confirm the receipt of the item at the delivery location. The notification may include an image of the recipient to provide visual assurance to the online customer of the delivery of the item at the delivery location and the online customer may select the hyperlink to provide confirmation of the receipt of the item at the delivery location.

At operation 812, payment to the online seller is processed subsequent to receiving confirmation of the receipt of the item at the delivery location from the user. Subsequent to receiving confirmation of the receipt of the item from the user, the server system is configured to transfer the money from the user account to an online seller account (e.g., acquirer 106 of FIG. 1) associated with the online seller. This may be enabled by the server system by retrieving the stored money from the corresponding user account that is linked to the transaction ID, and facilitating the transfer of the money from the user account to an online seller account associated with the online seller for processing payment to the online seller. Thus, the payment for an item purchased online may be executed subsequent to the delivery of the item at the delivery location.

The method 800 ends at operation 812.

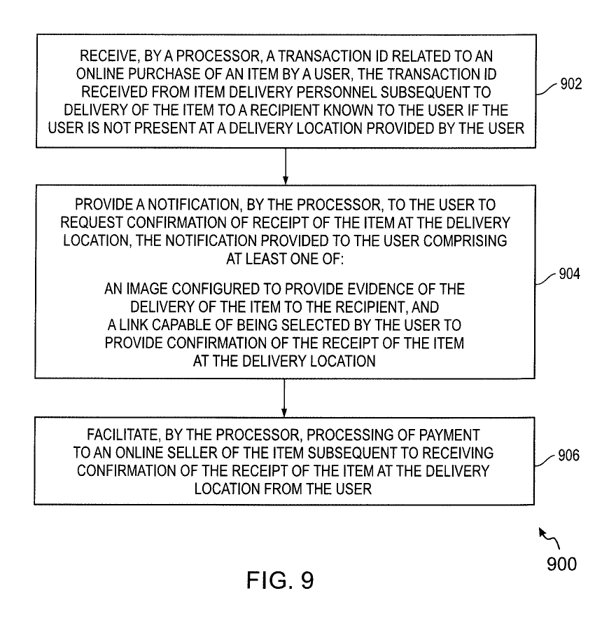

FIG. 9 is a flow diagram of an example method 900 for facilitating payments for items delivered at delivery locations, in accordance with another embodiment of the present invention. The method 900 depicted in the flow diagram may be executed by, for example, the server system 202 explained with reference to FIG. 2. Alternatively, the method 900 may be executed by a processor in any computing device configured to include machine instructions for facilitating payments of items delivered at delivery locations as explained with reference to FIGS. 2 to 6B. The method 900 starts at operation 902.

At operation 902, a transaction ID related to an online purchase of an item is received by a processor, such as the processor 302 of the server system 202. The transaction ID is received from item delivery personnel subsequent to delivery of the item to a recipient known to a user (i.e. the online customer) associated with the online purchase of the item if the user is not present at a delivery location.

At operation 904, a notification is provided by the processor to the user to request confirmation of receipt of the item at the delivery location. The notification provided to the user includes at least one of: an image configured to provide evidence of the delivery of the item to the recipient, and a link capable of being selected by the user to provide confirmation of the receipt of the item at the delivery location.

At operation 906, processing of payment to an online seller of the item is facilitated by the processor subsequent to receiving confirmation of the receipt of the item at the delivery location from the user. The processing of the payment is explained with reference to operation 812 and is not explained again herein.

The disclosed methods 800 and 900 or one or more operations of the methods 800 and 900 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Various example embodiments offer, among other benefits, techniques for efficiently facilitating payments for items delivered at delivered locations. The methods and system disclosed herein enable the online customers to choose the POD option during the online purchase of their respective items and still be able to receive and pay for items in spite of not being present at the delivery locations specified by them during their respective online purchase of the items. The items may be delivered as per the delivery schedule without having the need to send back the items if the intended recipients of the items are not available at the respective delivery locations to receive the items, thereby saving on sizable cost for the online sellers. Moreover, the online customers are happy as the items are delivered as per the delivery schedule and they do not have to endure their items being sent back and redelivered at a later point in time.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the systems and methods may be embodied using transistors, logic gates, and electrical circuits (for example, application specific integrated circuit (ASIC) circuitry and/or in Digital Signal Processor (DSP) circuitry).

Particularly, the server system 202 and its various components such as the computer system 204 and the database 206 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations (for example, operations explained herein with reference to FIGS. 7-9). A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system associated with a payment network, payment card information provided by a user in relation to an online purchase of an item, wherein the online purchase of the item is associated with selection of a Payment on Delivery (POD) option by the user, the selection of the POD option configured to instruct the payment network to process payment to an online seller of the item subsequent to delivery of the item to a delivery location provided by the user;
determining, by the server system, if the online purchase of the item is authorized based, at least in part, on verifying the payment card information;
if the online purchase is authorized, receiving a transaction ID associated with the online purchase of the item by the server system, the transaction ID generated by the online seller of the item;
subsequent to the delivery of the item to the delivery location, receiving the transaction ID, by the server system, from item delivery personnel;
providing a notification, by the server system, to the user to request confirmation of receipt of the item at the delivery location, the notification provided in response to the transaction ID received from the item delivery personnel; and
processing, by the server system, payment to the online seller subsequent to receiving confirmation of the receipt of the item at the delivery location from the user.

2. The method as claimed in claim 1, wherein the item is delivered to a recipient known to the user if the user is not present at the delivery location.

3. The method as claimed in claim 2, wherein the notification provided to the user comprises an image configured to provide evidence of the delivery of the item to the recipient.

4. The method as claimed in claim 1, wherein the notification provided to the user comprises a link capable of being selected by the user to provide confirmation of the receipt of the item at the delivery location.

5. The method as claimed in claim 1, wherein the transaction ID is shared with the item delivery personnel assigned with delivering the item to the delivery location, the transaction ID shared prior to the delivery of the item to the delivery location.

6. The method as claimed in claim 1, wherein an electronic device associated with the item delivery personnel comprises an application configured to:
receive an input related to the transaction ID and an image configured to provide evidence of the delivery of the item to the delivery location; and
provision the transaction ID and the image to at least one of the online seller of the item and the server system associated with the payment network.

7. The method as claimed in claim 1, wherein the payment card information comprises at least one of a payment card number, a payment card expiry date and a payment card verification value.

8. The method as claimed in claim 1, further comprising:
receiving, by the server system, at least one phone number provided by the user in relation to the online purchase of the item.

9. The method as claimed in claim 8, wherein the notification is sent to the at least one phone number by the server system.

10. The method as claimed in claim 8, further comprising:
facilitating, by the server system, a transfer of money equivalent to a billed amount corresponding to the online purchase of the item, the money transferred from a banking account linked with the payment card information to a user account from among the plurality of user accounts in a database, wherein the user account is linked to the transaction ID and the at least one phone number associated with the user.

11. The method as claimed in claim 10, wherein processing payment to the online seller comprises transferring the money from the user account to an online seller account associated with the online seller.

12. The method as claimed in claim 1, wherein the online purchase is executed on an Electronic commerce (e-commerce) portal, and wherein a User Interface (UI) associated with the e-commerce portal is configured to display the POD option to the user for facilitating a selection of the POD option in relation to the online purchase of the item.

13. A server system associated with a payment network, the server system comprising:
a processor configured to:
receive payment card information provided by a user in relation to an online purchase of an item, wherein the online purchase of the item is associated with selection of a Payment on Delivery (POD) option by the user, the selection of the POD option configured to instruct the payment network to process payment to an online seller of the item subsequent to delivery of the item to a delivery location provided by the user, and
determine if the online purchase of the item is authorized based, at least in part, on verifying the payment card information; and
a communication interface in operative communication with the processor, the communication interface configured to:
receive a transaction ID associated with the online purchase of the item if the online purchase is authorized, the transaction ID generated by the online seller of the item;
subsequent to the delivery of the item to the delivery location, receive the transaction ID from item delivery personnel, and
provide a notification to the user to request confirmation of receipt of the item at the delivery location, the notification provided in response to the transaction ID received from the item delivery personnel,
wherein the processor is configured to process payment to the online seller subsequent to receiving confirmation of the receipt of the item at the delivery location from the user.

14. The server system as claimed in claim 13, wherein the item is delivered to a recipient known to the user if the user is not present at the delivery location.

15. The server system as claimed in claim 14, wherein the notification provided to the user comprises at least one of:
an image configured to provide evidence of the delivery of the item to the recipient; and
a link capable of being selected by the user to provide confirmation of the receipt of the item at the delivery location.

16. The server system as claimed in claim 13, wherein the communication interface is further configured to:
receive at least one phone number provided by the user in relation to the online purchase of the item, wherein the notification is sent to the at least one phone number.

17. The server system as claimed in claim 13, further comprising:
a database configured to store a plurality of user accounts, each user account comprising information related to one or more payment cards associated with respective user, each payment card from among the one or more payment cards capable of facilitating at least one financial transaction.

18. The server system as claimed in claim 17, wherein the processor is further configured to:
facilitate a transfer of money equivalent to a billed amount corresponding to the online purchase of the item, the money transferred from a banking account linked with the payment card information to a user account from among the plurality of user accounts in the database, the user account corresponding to the user associated with the payment card information, wherein the money stored in the user account is linked to the transaction ID and the at least one phone number associated with the user, and wherein the money is transferred from the user account to an online seller account associated with the online seller for processing payment to the online seller.

19. A computer-implemented method, comprising:
receiving, by a processor, a transaction ID related to an online purchase of an item by a user, the transaction ID received from item delivery personnel subsequent to delivery of the item to a recipient known to the user if the user is not present at a delivery location provided by the user;
providing a notification, by the processor, to the user to request confirmation of receipt of the item at the delivery location, the notification provided to the user comprising at least one of:
an image configured to provide evidence of the delivery of the item to the recipient; and
a link capable of being selected by the user to provide confirmation of the receipt of the item at the delivery location; and
facilitating, by the processor, processing of payment to an online seller of the item subsequent to receiving confirmation of the receipt of the item at the delivery location from the user.

20. The method as claimed in claim 19, further comprising receiving by the processor:
payment card information provided by the user in relation to the online purchase of the item, wherein the online purchase of the item is associated with selection of a Payment on Delivery (POD) option by the user, the selection of the POD option configured to instruct the processor to facilitate processing of payment to the online seller of the item subsequent to the delivery of the item to the delivery location; and
at least one phone number provided by the user in relation to the online purchase of the item, wherein the notification is sent to the at least one phone number.
